(19) United States
(12) Patent Application Publication
(10) Pub. No.: US 2009/0025049 A1
(43) Pub. Date: Jan. 22, 2009

(54) SYSTEM AND METHOD OF ACCESSING INTERNET INFORMATION THROUGH PERSONALIZED TELEVISION APPARATUS

(75) Inventor: Xu Dong, San Jose, CA (US)

Correspondence Address: FAY SHARPE LLP, 1100 SUPERIOR AVENUE, SEVENTH FLOOR, CLEVELAND, OH, 44114, US

(73) Assignee: PowerLayer Microsystems Holding Inc., Grand Cayman (KY)

(21) Appl. No.: 12/172,482

(22) Filed: Jul. 14, 2008

(30) Foreign Application Priority Data
Jul. 16, 2007 (CN) 200710130308.8

(51) Int. Cl. H04N 7/173

(52) U.S. Cl. 725/93

(57) ABSTRACT

This document discloses a system and a method, both of which use a personalized television apparatus to access entertainment information from the Internet. It belongs in the television and communication areas. The said system includes but is not limited to a television apparatus with identifier, index server and source server. The said method includes but is not limited to the television apparatus with identifier, which searches for the required program information from the index website and finds the link address of the said program information. The said television apparatus logs into the corresponding website according to the link and accesses the content of the program from the source website. The invention enhances the speed of accessing information from the Internet by adding the information-accessing apparatus and establishing an index website. It makes full use of existing network resources and thereby reduces the cost of using the network.

### FIELD OF THE INVENTION

This invention is in the television communication field and involves a system and method of accessing the information through personalized television apparatus.

### BACKGROUND OF THE INVENTION

Television is one of the best entertainment devices invented in 20th century. However in the Internet connected 21st century, television by itself does not seem adequate. Existing television apparatus can only receive programs transmitted by broadcasters. Millions of programs available from different sources, such as the Internet, are not reachable by television viewers through today's television apparatus.

The Internet has expanded rapidly in the last 10 years; many in the younger generations browse the Internet everyday. As the result, the telecommunication industry has also grown in the last decade. With reasonable transmission speed, bandwidth and cost to the home consumer, many online video content providers such as YouTube and Tudou provides a hundred times more information than today's broadcasters do. To enrich the content of television programs, television needs a powerful search engine. However, the existing technology is not mature enough.

### DETAILED DESCRIPTION OF THE PREFERRED EMBODIMENT

To enrich the content of television programming, the said invention provides a system and method of accessing information through personalized television apparatus, comprising

A system of accessing information through personalized television apparatus with an identifier, index server and source server.

The said television apparatus connects to the said index server and the said source server through a network port, accesses the link address of the required program information from the said index server, and accesses the required program content through the link address from the said source server.

The said index server and the said source server connect to the Internet. The said index server provides the index information of the program to the said television apparatus based on the content from the said source server, and records the identifier and log-in information of the said television apparatus.

The said television apparatus includes:
The index searching module, which searches the required program information from the index server and finds the link address for the program information;
The content accessing module, which logs in the source server according to the link address provided by the index sever and accesses the required program content from the source server;
The said index server includes an index information providing module, which provides index information to the said television apparatus in the form of a database. The said database includes the names of television program and the link address;
The log-in information recording module, which records the log-in information of the television apparatus. The log-in information includes the identifier of the television apparatus, the contents that are selected by the television apparatus, and the log-in times of the television apparatus;
The said index server includes an updated module, which regularly updates the program index information of the index information providing module according to the updated content of the source server. The said source server includes a program content providing module, which provides program contents to the television apparatus.

Note: The said source server and the said index server can be the same server.

The invention also provides a method of accessing information through personalized television apparatus and establishes an index website in advance that implements the following process:
The television apparatus with identifier finds the information for the required program from the said index website with the index searching module and accesses the corresponding link address.
   The said index website records the log-in information of the said television apparatus.
The said television apparatus logs in the source website through the link address and accesses the contents of the required program.
   The said source website records the log-in information of the said television apparatus.
   The said source website provides contents including video, audio, blog, fiction, news, animation and advertising.

The information of the said index website is updated regularly.

The said processes of establishing an index website in advance include:
Applying for a website on the Internet;

Setting up a database on the website; and
Collecting information on the Internet and recording the needed information on the said database. The said database includes:
The names of programs and link addresses.
   The category, index, keywords, payment information, copyright information, file location, downloading methods and the corresponding decoder.
   The said log-in information, which includes the identifier of the said television apparatus, selected contents of the said television apparatus and log-in times of the said television apparatus.
   The identifier of the said television apparatus provides information including the name of the television apparatus manufacturer, the serial number of the television apparatus and the IP address.

The benefits of this invention include:
Through the added information accessing apparatus and the established index website, a television apparatus can use the programming resources of the Internet without searching by personal computer or another auxiliary apparatus.

### DRAWINGS OF THE INVENTION

FIG. 1 is a sketch map of the system of accessing information through personalized television apparatus.

FIG. 2 is a flow chart of the method of accessing information through personalized television apparatus.

### DETAILED IMPLEMENTATION OF THE INVENTION

To further discuss the purpose and advantages of the invention and its technical scheme, two implementations of the invention are detailed below with drawings and descriptions.

The invention provides technological solutions that accesses related information of the required program and accesses the content of the programs based on the link information. It allows television apparatus to provide personalized services.

### Implementation Example 1

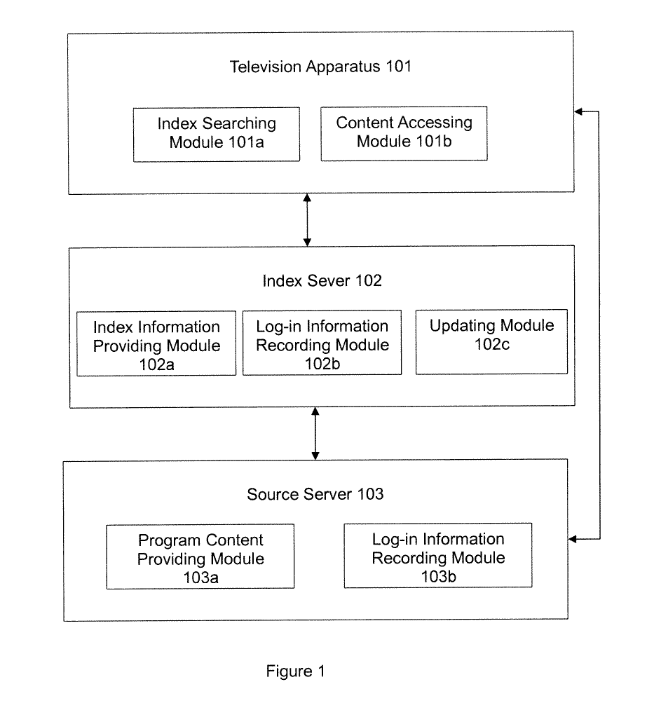

In FIG. 1, the implementation provides a system of accessing information through personalized television apparatus. The system includes a television apparatus with Identifier 101, Index Server 102 and Source Server 103.
Television Apparatus 101 connects Index Server 102 and Source Server 103 through a network port, obtains the link address for the required program information, and accesses the contents of the required program through the link address from Source Server 103.
Index Server 102 and Source Server 103 connect to Internet.
   Index Server 102 provides the index information of programs to Television Apparatus 101 based on the content from Sources Server 103, and records the identifier and log-in information of Television Apparatus 101.
   Sources Server 103 provides the program content and records the identifier and log-in information of Television Apparatus 101.
Television Apparatus 101 includes an Index Searching Module 101a, which finds the required program information from Index Server 102 according to the corresponding link address.
   Content Accessing Module 101b logs in to Source Server 103 according to the link address provided by Index Server 102 and accesses the content of the program from Source Server 103.

Television Apparatus 101 and its function are not the focus of the invention and therefore will not be explained in detail. The application of CN200710107605.0 can provide the related information.

Index Server 102 includes:
Index Information Providing Module 102a, which provides the index information of the program to Television Apparatus 101 in the form of a database. The database includes names of the television programs and link addresses.
Log-in Information Recording Module 102b, which records the log-in information of Television Apparatus 101. The log-in information includes the identifier of the television apparatus, the contents selected by the television apparatus and the times of log-in.
   Updating Module C, which provides updated program index information to the Index Information Providing Module 102a according to the updated information of Source Server 103.

Source Server 103 includes:
Program Content Providing Module 103a, which provides program content to the television apparatus.
Log-in Information Recording Module 103b, which records the log-in information of the television apparatus. The log-in information includes the identifier of the television apparatus, the content selected by the television apparatus and the times of log-in.
An identifier of the television apparatus, which includes the name of the television apparatus manufacturer, the series number of the television apparatus, the IP address and so on.

Note: Source Server 103 and Index Server 102 can be either the same server or not.

### Implementation Example 2

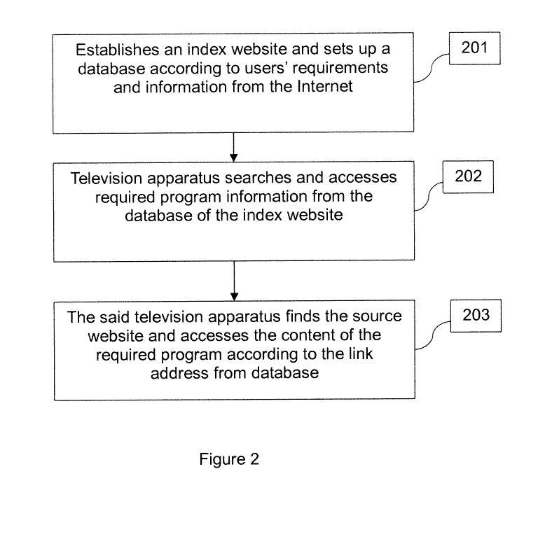

In FIG. 2, the implementation provides a system of accessing information through personalized television apparatus. The method includes the following processes:
Step 201: Create an index website according to the user's requirement and the information from the Internet and set up a database, which includes but is not limited to:
   The names, type, index, keyword, payment information, copyright information, file location, the network link, download information, and the corresponding decoder of television programs.
Step 202: The television apparatus with identifier searches the database of the index website through an index searching module and accesses the information for the required program from the database. The identifier of the television apparatus, which provides information, includes but is not limited to:
The manufacturers, series number, IP address of the television apparatus.
Step 203: The television apparatus finds the corresponding source website according to the link address, which is provided by the database, and finds the content of the required program.
At the same time, the said source website provides the log-in information of the television apparatus, such as the identifier, the content selected by the television apparatus and the log-in times.
   The said source website, which provides content, includes:
      Video, audio, blog, fiction, news, animation and advertising, and other information.

To better record the television apparatus log-in or clicking times. A counter device can be set. Through the counter, we can get the total number of television apparatus accessing an online program, or the total number of television apparatus made by one manufacturer accessing an online program or the total number of times one television apparatus accesses an online program during a certain time period.
According to the results of the counter, advertisement vendor can pay ad-rate to the index website, television apparatus manufacturers and even the customers of the television apparatus owner. Television program content providers can collect fees from television viewers based on the results of the counter, which records the identifier of visiting television apparatus.
   For example, when an ad vendor is a source website, every television apparatus must view the ad information from the source website through the index website. The ad vendor must pay ad-rate to the index website, the television apparatus manufacturers and even the television apparatus users according to the results provided by the counter device.
The database of index websites can be updated regularly according to the (user's) requirement. Also, the database can be updated according to the viewing history of the customer over a period of time, while useless information in the database can be deleted and the storage space for found information can be enlarged.

The above implementation improves the efficiency of accessing information from the network by adding an index searching module to television apparatus and establishing an index website. It takes full advantage of existing network resources and provides more and better television programs to viewers.

The above is only a better implementation of the invention, not the full extent of the invention. Any changes that are in the spirit or principles of the invention should be included in the protection of this invention range.

We claim:

1. A system of accessing information through personalized television, including the television apparatus with identifier, index server and source sever;
The said television apparatus connects to the index server and source server through a network port separately, obtains the link address for the required program information from the index server, and accesses the content of the program from the source server through the link address.
The said index server and the said source server connect to the Internet. The index server provides the index information of the programs to the television apparatus according to the content of the source server and records the identifier and log-in information of the said television apparatus.
The said source server provides program contents to the television apparatus and records the identifier and log-in information of the television apparatus.

2. In the said system of accessing information through personalized television apparatus of claim 1, the television apparatus includes:
Index search module, which finds the required program information from the index server and provides the corresponding link address according to the program information.
Content accessing module, which logs in to the source server according to the link address provided by the index server and accesses the required program contents from the said source server.

3. In the said system of accessing information through personalized television apparatus of claim 1, the index server includes:
Index information providing module, which provides the program index information to the said television apparatus in the form of a database. The said database includes television programs' names and link addresses.
Log-in information recording module, which records the log-in information of the accessing television apparatus. The log-in information includes the identifier of the television apparatus, the content selected by the television apparatus, and the times of television apparatus' log-in.

4. In the said system of accessing information through personalized television apparatus of claim 1, the index server includes:
Updating modules, which can regularly update the program index information of the said index information providing modules according to the content provided by the said source server.

5. In the said system of accessing information through personalized television apparatus of claim 1, the said sources include:
Program content providing module, which provides the content of programs to the said television apparatus;
(B) Log-in information recording module, which records the log-in information of the television apparatus. The login information includes the identifier of the television apparatus, content that is selected by the television apparatus, and the log-in times.

6. In the said system of accessing information through personalized television apparatus of claim 1, the said source server and the said index server are the same server.

7. A method of accessing information through personalized television apparatus is establishing an index website in advance, then implementing the following processes:
The television apparatus with identifier, which finds the information of the required program through the index search module and obtains the corresponding link address.
The said television apparatus logs into the source website directed by the link addresses and accesses the content of the selected program.

8. The said method of accessing information through personalized television apparatus of claim 7 includes:
Update information of the said index website regularly.

9. In the said method of accessing information through personalized television apparatus of claim 7, the processes of establishing an index website in advance includes:
Creating a website and setting up a database on the website.
Collecting information from the Internet and recording the needed information in the said database.

10. In the said method of accessing information through personalized television apparatus of claim 7, the database includes:
Names of television programs and the respective link addresses.

11. In the said method of accessing information through personalized television apparatus of claim 7, the database includes:
The category, index, keywords, payment information, copyright information, file location, downloading methods and the corresponding decoder.

12. The said method of accessing information through personalized television of claim 7 includes:
The log-in information of the said television apparatus that is recorded by the said index website.
The log-in information of the television apparatus that is recorded by the said source website.

13. In the said method of accessing information through personalized television apparatus of claims 12, the recorded log-in information includes:
The identifier of the said television apparatus, contents selected by the said television apparatus, log-in times of the said television apparatus.

14. In the said method of accessing information through personalized television apparatus of claim 7, the content provided by the said source website includes:
Video, audio, blog, fiction, news, animation and advertising.

15. In the said method of accessing information through personalized television apparatus of claim 7, the information of the identifier includes:
The names of the television apparatus manufacturers, serial numbers of the television apparatus and link addresses.
